(19) United States
(12) Patent Application Publication
(10) Pub. No.: US 2025/0021709 A1
(43) Pub. Date: Jan. 16, 2025

(54) SYSTEMS, METHODS, AND MEDIA FOR PRESENTING A UNIFIED DIGITAL DELIVERABLE OF AN INFRASTRUCTURE

(71) Applicant: Bentley Systems, Incorporated, Exton, PA (US)

(72) Inventors: Joey LouAllen, Moulton, AL (US); Diego Alexander Diaz Pabon, West Hartford, CT (US)

(21) Appl. No.: 18/221,142

(22) Filed: Jul. 12, 2023

(51) Int. Cl. G06F 30/13; G06F 30/12

(52) U.S. Cl. CPC G06F 30/13; G06F 30/12; G06F 2111/20

(57) ABSTRACT

Techniques are provided for presenting a unified digital deliverable (UDD) of an infrastructure. An assemblage of the infrastructure may include at least one plan sheet of the infrastructure and a three-dimensional (3D) model of the infrastructure. An object from a perspective of the infrastructure may be selected. Based on the selection, a processor may (1) present the UDD of the infrastructure, (2) navigate to different perspectives of the infrastructure included in the UDD, and/or (2) present data that corresponds to the selected object and that is maintained with the UDD. For example, an object may be selected from a plan sheet. A processor may present the UDD of the infrastructure. The UDD may include selectable objects corresponding to the infrastructure such that a user can select an object from the UDD to navigate through different perspectives and investigate and learn about the planning, design, constructions, and/or operation of the infrastructure.

### BACKGROUND

### Technical Field

The present disclosure relates generally to digital deliverables for an infrastructure, and more specifically to presenting a unified digital deliverable.

### Background Information

In the design, construction and/or operation of an infrastructure (e.g., buildings, factories, roads, railways, bridges, electrical and communication networks, equipment, storm water systems, etc.) designers often create models, e.g., three-dimensional (3D) high-resolution models, of a scene in which the infrastructure is built, or planned to be built. The models typically include underlying information that describes the characteristics of the infrastructure and/or environment in which the infrastructure is or will be deployed.

Such models are typically created utilizing infrastructure modeling software (e.g., an infrastructure modeling application) with different commands, rules, and syntax that need to be learned so that a user can manipulate the model in the software. Therefore, and because of their continued use of infrastructure modeling software, designers are comfortable using such software to manipulate the 3D model to, for example, understand the construction and/or operation of the infrastructure.

However, there are other individuals who are integral to the construction and/or operation of the infrastructure who are typically unfamiliar with utilizing such infrastructure modeling software. Such individuals may include, but are not limited to, engineers, contractors, surveyors, reviewers, inspectors, etc. Because of their unfamiliarity with the infrastructure modeling software and the use of 3D models in general, these individuals cannot easily manipulate the 3D model using the software to understand the construction and/or operation of the infrastructure. As a result, these individuals cannot easily obtain and evaluate the underlying information for the infrastructure that is stored with the 3D model.

Instead of being familiar with infrastructure modeling software, these individuals are typically comfortable using plan sheets that are considered a common deliverable in the industry (e.g., infrastructure planning, design, and/or construction). However, plan sheets are static and cannot be manipulated to, for example, obtain underlying data. For example, an object cannot be selected in a conventional plan sheet to obtain underlying data corresponding to the object. Because of their familiarity with plan sheets and lack of familiarity with infrastructure modeling software, these other types of users are at a disadvantage when using conventional techniques to understand the construction and/or operation of an infrastructure.

### SUMMARY

Techniques are provided for presenting a unified digital deliverable (UDD) according to the one or more embodiments as described herein.

In an embodiment, a processor, e.g., a UDD module executed by the processor, may obtain an assemblage of an infrastructure that includes linked perspectives. The perspectives of the assemblage may include at least two of (1) a two-dimensional (2D) schematic of the infrastructure, (2) a three-dimensional (3D) schematic of the infrastructure, (3) one or more plan sheets of the infrastructure, and (4) data (e.g., characteristic information) corresponding to the objects of the infrastructure that are included in the 2D schematic, 3D schematic, and/or plan sheets.

An object of a plan sheet of the assemblage may be identified. For example, a user may use an input device of a client device to select an object from a plan sheet.

Based on the selection, the processor may identify the object. The processor may determine if a linked 3D object exists for the object selected from the plan sheet. Specifically, and in certain instances, a 3D model of an infrastructure may not include a 3D representation of an object that is included in the plan sheet. If a 3D object does not exist, the processor may provide a notification indicating that the 3D object does not exist.

If the 3D object exists, the processor may generate an interface node on a user interface. In an embodiment, the interface node may be a selectable, e.g., clickable, radio button, a selectable checkbox, a selectable drop-down menu, or any other type of interface node that may be selectable or may be identified on a user interface. In an embodiment, generating an interface node comprises transforming each object in the plan sheet from being a static object to being a clickable/selectable object.

In response to the interface node being selected, the processor presents a UDD for the infrastructure. In an embodiment, presenting the UDD for an infrastructure includes displaying, on a computer display, at least (1) a plan sheet for an infrastructure and (2) a 3D schematic, e.g., model, of the infrastructure that includes one or more objects included in the displayed plan sheet. In an embodiment, presenting the UDD for an infrastructure includes displaying, on a computer display, at least (1) a plan sheet for an infrastructure, (2) a 3D schematic, e.g., model, of the infrastructure that includes one or more objects included in the displayed plan sheet, and (3) characteristic information corresponding to the one or more objects included in the displayed plan sheet and the 3D schematic.

In an embodiment, the processor may filter the plan sheets that make up a plan set based on one or more of (1) selecting an object from a plan sheet before presenting the UDD, (2) selecting an interface node generated according to the one or more embodiments as described herein, or (3) selecting an object from the presented UDD.

### BRIEF DESCRIPTION OF THE DRAWINGS

The description below refers to the accompanying drawings, of which:

FIG. 1 is a high-level block diagram of an example architecture for presenting a unified digital deliverable (UDD) of an infrastructure according to one or more embodiments as described herein;

FIG. 2 is a flow diagram of a sequence of steps for presenting a UDD of an infrastructure based on identification of an object from a plan sheet associated with the infrastructure according to the one or more embodiments as described herein;

FIG. 3 is an illustration of an example plan sheet for an assemblage of an example infrastructure that is a storm water system according to the one or more embodiments as described herein;

FIG. 4 is an illustration of an example portion of a 3D schematic for the assemblage of the example infrastructure that is the storm water system according to the one or more embodiments as described herein;

FIG. 5 is an illustration of an example portion of a 2D schematic for the assemblage of the example infrastructure that is the storm water system according to the one or more embodiments as described herein;

FIG. 6 is a plan sheet corresponding to FIG. 3 that includes an interface node according to the one or more embodiments as described herein;

FIG. 7A is an illustration of an example UDD for an infrastructure according to the one or more embodiments as described herein; and

FIG. 7B is an illustration of a different example UDD for an infrastructure according to the one or more embodiments as described herein.

### DETAILED DESCRIPTION OF AN ILLUSTRATIVE EMBODIMENT

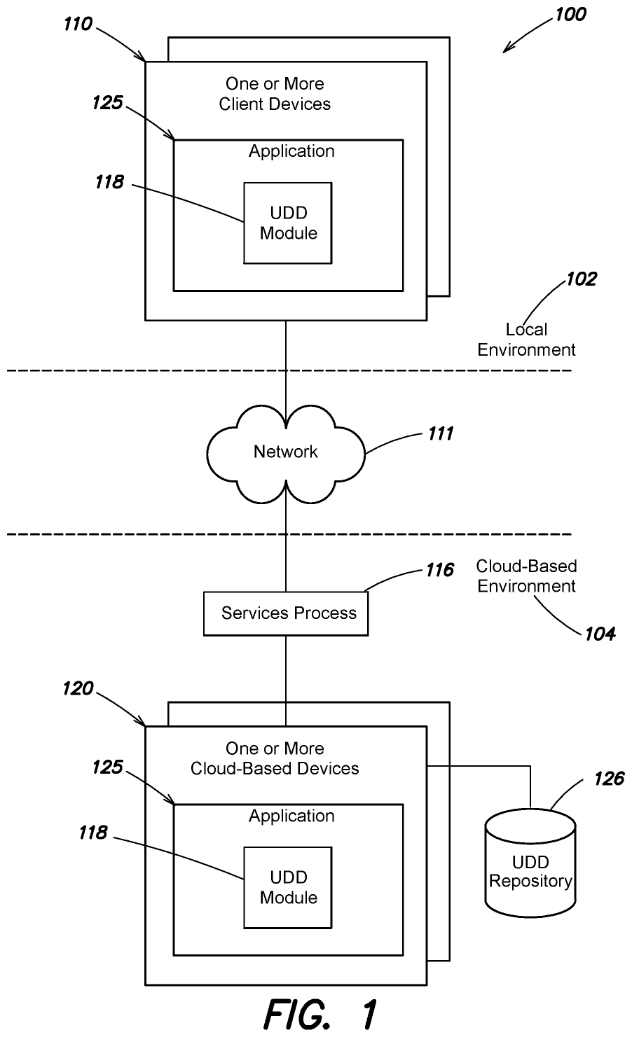

FIG. 1 is a high-level block diagram of an example architecture 100 for presenting a unified digital deliverable (UDD) of an infrastructure according to one or more embodiments as described herein. The architecture 100 may be divided into a local environment 102 that includes one or more local client devices 110 that are local to an end-user, and a cloud-based environment 104 that includes one or more cloud-based client devices 120 that are remote from the end-user and that are accessible to the end-user via a network 111 (e.g., the Internet). Each computing device, e.g., one or more local client devices 110 and one or more cloud-based client devices 120, may include processors, memory/storage, a display screen, and other hardware (not shown) for executing software/modules, storing data, and/or displaying information.

A local client device 110 may provide a variety of user interfaces and non-processing intensive functions. For example, a local client device 110 may provide a user interface, e.g., a graphical user interface and/or a command line interface, for receiving user input and displaying output according to the one or more embodiments described herein. A services process 116 may coordinate operation of the one or more local client devices 110 and the one or more cloud-based client devices 120 such that, for example, the one or more local client devices 110 may communicate with and access the one or more cloud-based client devices 120 via network 111.

The one or more client devices 110 and/or one or more cloud-based client devices 120 may store and execute application 125. Application 125 may present a UDD of an infrastructure in a variety of different ways based on, for example, user input according to the one or more embodiments as described herein and as will be described in further detail below. In an embodiment, the application 125 may be infrastructure modeling software that may (1) generate and present one or more plan sets for an infrastructure and/or (2) generate and execute one or more models (2D and/or 3D models) of the infrastructure (e.g., real-world infrastructure) to simulate the behavior and/or operation of the infrastructure.

In an embodiment, the infrastructure modeling software may be offered by Bentley Systems Inc. Application 125 may be referred to as an application or an UDD application.

In an embodiment, the one or more local client devices 110 may download and store application 125. In an embodiment, the one or more local client devices 110 may utilize one or more user interfaces to access, via services process 116, the application 125 that is stored on the one or more cloud-based client devices 120 according to the one or more embodiments as described herein. Additionally, the one or more local client devices 110 may store one or more UDDs locally or may access one or more UDDs that may be stored on UDD repository 126. In an embodiment, data repository 126 may be a database (e.g., relational database), hard disk drives, solid-state drives, etc.

The application may include UDD module 118. The UDD module 118 may present a UDD of an infrastructure in a variety of different ways based on, for example, user input according to the one or more embodiments as described herein and as will be described in further detail below. Specifically, the UDD module 118 may receive input with relation to a plan sheet of an assemblage for an infrastructure. In response to the input, the UDD module 118 may present a UDD of the infrastructure that can be manipulated to provide information to users regarding the construction and/or operation of the infrastructure. Therefore, the UDD for an infrastructure according to the one or more embodiments as described herein is “smart” and interactive. Advantageously, a plan sheet, which is static for conventional systems, is interactive according to the one or more embodiments as described herein. As a result, a 3D model of the infrastructure is accessible via the interactive plan sheet according to the one or more embodiments as described herein.

It is expressly contemplated that the UDD module 118 may be hardware, software, or a combination thereof. In an embodiment, the processor (not shown) of a local client device 110 may be coupled to the memory (not shown) of the local client device 110, wherein the processor is configured to execute the UDD module 118. In addition or alternatively, the processor (not shown) of a cloud-based client device 120 may be coupled to the memory (not shown) of the cloud-based client device 120, wherein the processor is configured to execute the UDD module 118.

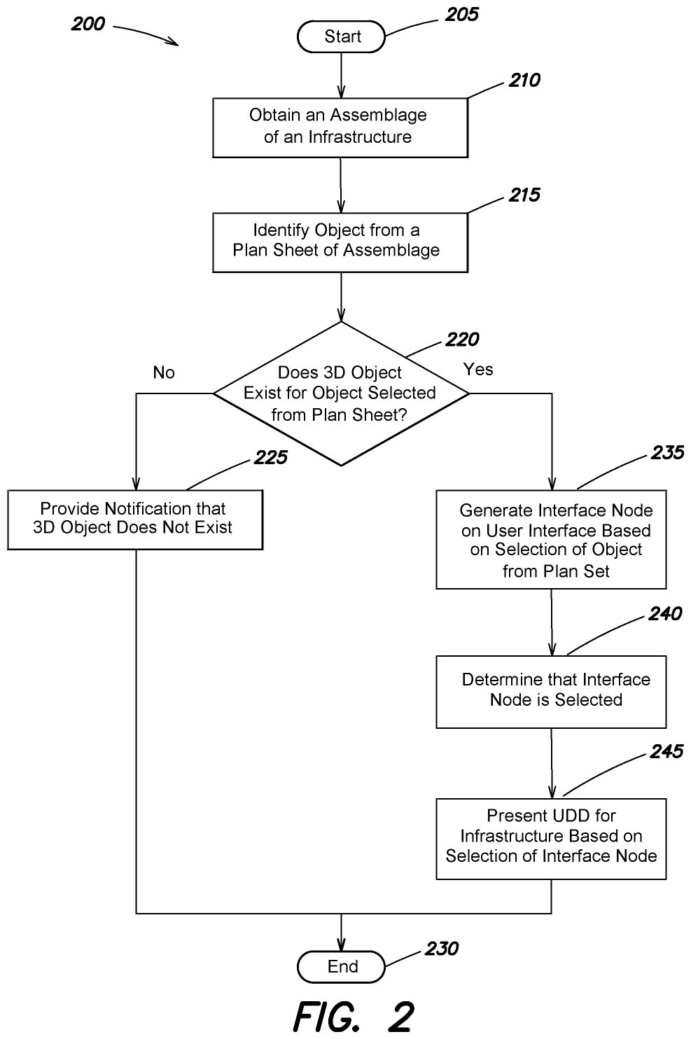

FIG. 2 is a flow diagram of a sequence of steps for presenting a UDD of an infrastructure based on identification of an object from a plan sheet associated with the infrastructure according to the one or more embodiments as described herein. The procedure 200 starts at step 205 and continues to step 210. At step 210, the UDD module 118 obtains an assemblage of an infrastructure. For the example as described with relation to FIG. 2, let it be assumed that the infrastructure is a storm water system that includes a plurality of pipes and a single inlet. In this example, each of the plurality of pipes and the inlet may be considered an artifact, element, entity, component, object etc. of the infrastructure, and such terms may be interchangeably.

According to the one or more embodiments as described herein, the assemblage includes a plurality of perspectives of the same infrastructure, and the plurality of perspectives may be linked together. In an embodiment, the plurality of perspectives include at least two of (1) 2D schematic of the infrastructure, (2) a 3D schematic of the infrastructure, (3) one or more plan sheets of the infrastructure, and (4) data (e.g., characteristic information) corresponding to the objects of the infrastructure that are included in the 2D schematic, 3D schematic, and/or plan sheets. In an embodiment, the assemblage may be stored in data repository 126.

The plurality of perspectives may be linked in any of a variety of different ways.

For example, each object in a perspective may be assigned a unique identifier, where the unique identifier is consistent for the object across the plurality of perspectives. For example, the inlet of the storm water system may have a unique identifier in the perspective of the 2D schematic, and the unique identifier assigned to the inlet is the same, i.e., consistent, for the inlet in the plan sheets and the 3D schematic. Although the example describes linking the plurality of perspectives using an identifier for objects included in the perspectives, it is expressly contemplated that the plurality of perspectives can be linked in any of a variety of different ways such that an object in a perspective can be identified in the other perspectives. As such, the example of using an identifier for linking perspectives is for illustrative purposes only.

As known by those skilled in the art, engineering information generated by computer aided design and drafting tools (CAD) software may consist of large format engineering plans, i.e., plan sheets, and specifications. Each plan sheet typically includes a title block that includes identifying information for the plan sheet and one or more drawings of the infrastructure. As known by those skilled in the art, an engineering plan set is a collections of plan sheets. There are established methods used in the engineering community for reading plan sets, and plan sets typically contain an index sheet that serves as a table of contents for the set. In an embodiment, a plan sheet may be any form of a static representation of an infrastructure that contains one or more defined views and/or graphical perspectives used to convey understanding to an audience for the planning, design, review, approval, construction, and/or operation, etc. of an infrastructure.”

In the industry of infrastructure planning, construction, and/or operation, a plan set with a collection of plan sheets is a common deliverable that is provided to those individuals that are involved with the planning, construction, and/or operation of the infrastructure. For example, and according to conventional systems and techniques, the plan set with the collection of plan sheets is a common deliverable that is distributed to engineers, contractors, surveyors, reviewers, inspectors, etc. These individuals typically use the plan sheets to obtain the necessary information required to properly implement infrastructure planning, construction, and/or operation. However, such static plan sets lack the robust information that, for example, is provided with 3D models of the infrastructure that are generated and manipulated utilizing infrastructure modeling software. Because these individuals are unfamiliar with the operation of the infrastructure modeling software (e.g., (different commands, rules, and syntax that needed to operate the software), these individuals are typically restricted to using the static plan sheets, and thus prevented from accessing all relevant information related to the infrastructure.

Each plan sheet of a plan set may be a particular view (e.g., perspective view, aerial view etc.) of a portion of the infrastructure. Each plan sheet may be defined by a spatial boundary that corresponds to a portion of the schematic drawings. For example, a first plan sheet for an infrastructure may have a first spatial boundary, and the first spatial boundary may correspond to a first portion/location in the 2D and/or 3D schematics of the infrastructure. Therefore, the first plan sheet would include representations of only those objects that are included in the first portion/location of the 2D and/or 3D schematics of the infrastructure.

Similarly, a second plan sheet for the infrastructure may have a second spatial boundary, and the second spatial boundary may correspond to a second portion/location in the 2D and/or 3D schematics of the infrastructure. Therefore, the second plan sheet would include representations of only those objects that are included in the second portion/location of the 2D and/or 3Ds schematics of the infrastructure. Of course, the first portion/location and the second portion/location in the schematic drawings may be the same, may overlap, or may be entirely different.

For the example of the storm water system, the plan sheets may include plan views of the inlet and the plurality of pipes along the entirety of the storm water system, elevation views of the inlet and the plurality of pipes along the entirety of the storm water system, cross-section views of the inlet and the plurality of pipes along the entirety of the storm water system, etc.

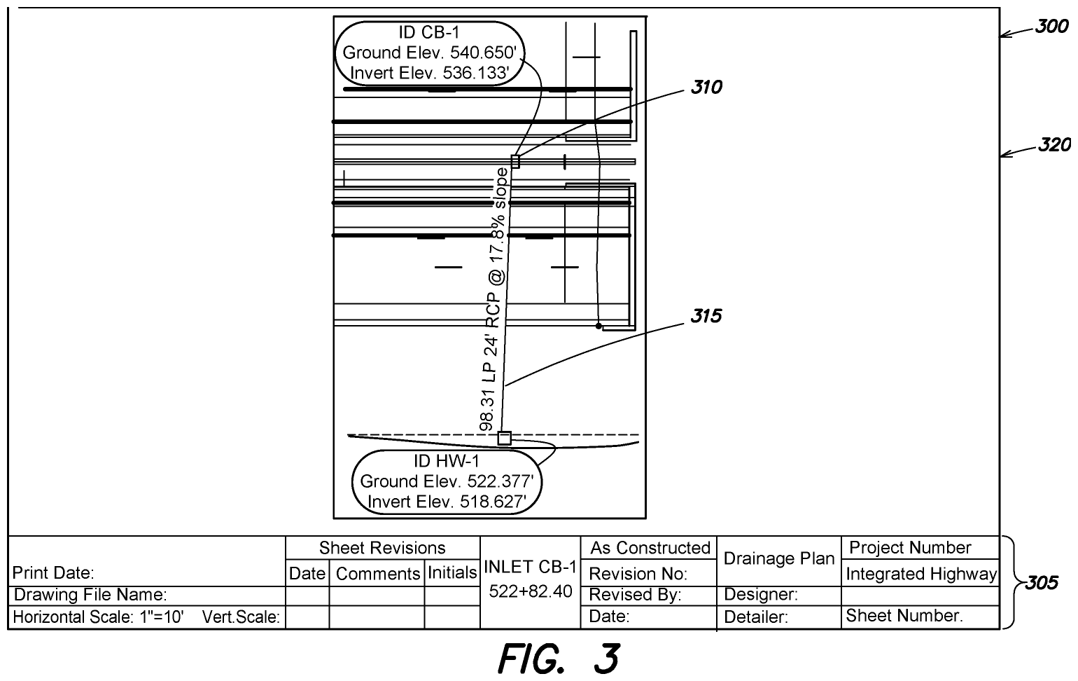

FIG. 3 is an illustration of an example plan sheet for an assemblage of an example infrastructure that is a storm water system according to the one or more embodiments as described herein. Plan sheet 300 corresponds to the storm water system as described herein. Plan sheet 300 includes a title section 305 that includes identifying information for plan sheet 300. Additionally, plan sheet 300 includes a drawing of inlet 310 and a drawing of a pipe 315 of the plurality of pipes that make up the storm water system. Further, plan sheet 300 includes spatial boundary 320 defining the spatial boundary of the plan sheet 300. The other lines/markings on plan sheet 300 may represent other objects in the real-world environment (e.g., bridge, road, etc.) that are not relevant to the example as described herein.

In an embodiment, the spatial boundary 320 corresponds to a portion of the 2D and/or 3D schematics of the infrastructure. For this example, the spatial boundary 320 of plant sheet 300 corresponds to the portion(s) of the 2D and/or 3D schematics of the storm water system that include the inlet and particular pipe that is connected to the inlet. Stated another way, plan sheet 300 does not include the other objects, e.g., the other of the plurality of pipes that make up the storm water system, that are outside the spatial boundary 320 and that are included in other portions of the 2D and/or 3D schematics of the storm water system.

According to the one or more embodiments as described herein, the plan sheet 300 may be linked to data describing the inlet and the pipe connected to the inlet. For example, the data may indicate the flow rate of the inlet, the size of the opening of the inlet, the inner circumference of the pipe that is connected to the inlet, etc. Further, the plan sheet 300 may be linked to portions of the 2D and 3D schematics of the storm water system that include the inlet and the pipe connected to the inlet. In an embodiment, plan sheet 300 may be generated using application 125 that may, for example, be modeling software, CAD software, and/or a combination of modeling and CAD software. Therefore, the linked plan sheet 300, according to the one or more embodiments as described herein, is different than a conventional static plan sheet that is not linked to other perspectives.

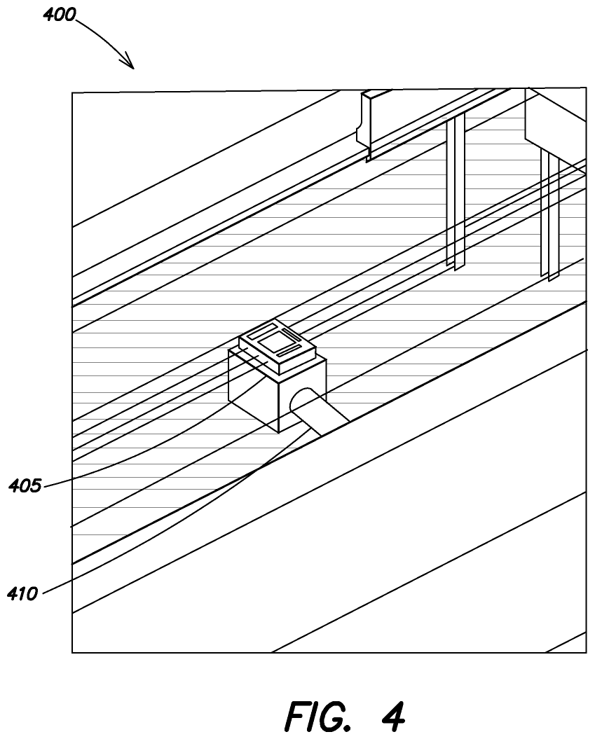

FIG. 4 is an illustration of an example portion of a 3D schematic for the assemblage of the example infrastructure that is the storm water system according to the one or more embodiments as described herein. The portion of the 3D schematic 400 of FIG. 4 includes a 3D representation of inlet 405 and a 3D representation of pipe 410 that is connected to inlet 405 in the storm water system. The portion of the 3D schematic 400, that includes the 3D representations of inlet 405 and pipe 410, may be linked to one or more plan sheets (e.g., plan sheet 300) that also includes the inlet and pipe that is connected to the inlet. The portion of the 3D schematic 400 may also be linked to the data describing the inlet and the pipe connected to the inlet. Further, the portion of the 3D schematic 400 may also be linked to portions of a 2D schematic that includes the inlet and the pipe that is connected to the inlet. In an embodiment, the portion of 3D schematic 400 may be generated using application 125 that may, for example, be modeling software, CAD software, and/or a combination of modeling and CAD software.

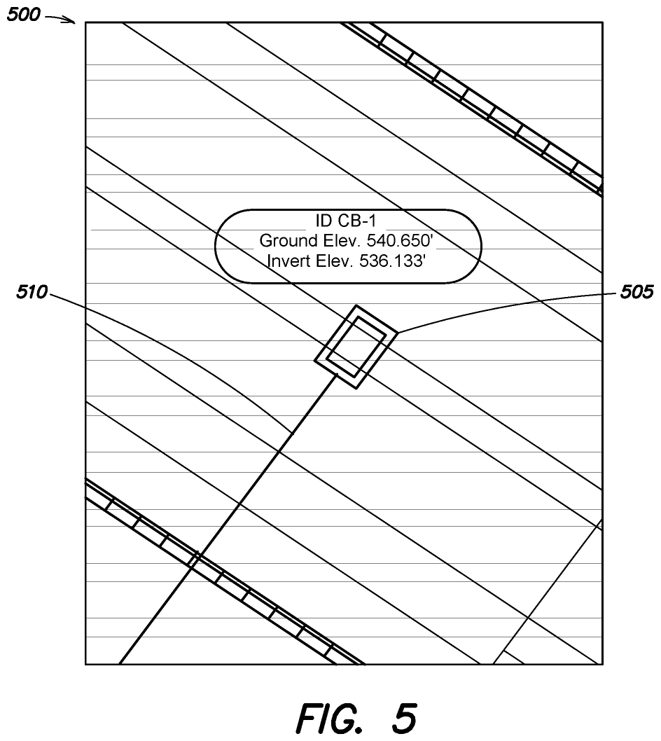

FIG. 5 is an illustration of an example portion of a 2D schematic for the assemblage of the example infrastructure that is the storm water system according to the one or more embodiments as described herein. The portion of the 2D schematic 500 of

FIG. 5 includes a 2D representation of inlet 505 and a 2D representation of pipe 510 that is connected to inlet 505 in the storm water system. The portion of the 2D schematic 200, that includes the 2D representations of inlet 505 and pipe 510, may be linked to the portion of the 3D schematic 400 that includes the 3D representations of inlet 405 and pipe 410. The portion of the 2D schematic 500 may also be linked to one or more plan sheets (e.g., plan sheet 300) that include the inlet and pipe that is connected to the inlet. The portion of the 2D schematic 500 may also be linked to the data describing the inlet and the pipe connected to the inlet. In an embodiment, the portion of the 2D schematic 500 may be generated using application 125 that may, for example, be modeling software, CAD software, and/or a combination of modeling and CAD software.

The example assemblage for the storm water system as described herein is for simplicity and illustrative purposes only. Specifically, the example assemblage includes a single plan sheet, a single portion of the 3D schematic of the storm water system, and a single portion of the 2D schematic of the storm water system. However, it is expressly contemplated that the assemblage, according to the one or more embodiments as described herein, may include (1) a plurality of plan sheets corresponding to different portions of an infrastructure, e.g., storm water system, that may be hierarchically arranged (the hierarchy of sheets may be referred to as a “sheet index”), (2) a plurality of 3D schematics of the infrastructure, and (3) a plurality of 2D schematics of the infrastructure, which all may be linked to each other and linked to characteristics data for the objects of the infrastructure. As such, the description of the example assemblage is for illustrative purposes only.

Referring back to FIG. 2, procedure 200 continues from step 210 to step 215 and an object from a plan sheet of the assemblage is identified. In an embodiment, the object from the plan sheet may be identified based on user input. Specifically, a user working with the project may review the digital versions of the plan sheets on client device 110. In this example, let it be assumed that an engineer working on the project of the storm water system is reviewing the digital plan sheets of the storm water system on client device 110 via application 125. Further, and in this example, let it be assumed that the engineer is responsible for the construction and deployment of the inlet, represented in the 2D and 3D schematics and plan sheet as described above, in the real-world storm water system. Therefore, and in this example, the engineer may be interested in obtaining more information, than what is provided in a conventional plan sheet, regarding the inlet of the storm water system.

As such, the engineer may select, using an input device (e.g., mouse, keyboard, etc.) of the client device 110, the inlet 310 from the plan sheet 300 according to the one or more embodiments as described herein. In response to receiving the selection of the inlet 310, the UDD module 118 may identify the inlet and all information corresponding to the inlet in the data repository 126. Specifically, and because the inlet is linked across all perspectives (e.g., 2D schematic, 3D schematic, plan sheets, characteristic information describing the inlet), the selection of the inlet 310 from plan sheet 300 allows the UDD module 118 to access the inlet of any of the linked perspectives.

In an embodiment, the UDD module 118 may filter the plurality of plan sheets that make up a plan set for the infrastructure based on the selection of an object from a plan sheet. For example, based on the selection of inlet from plan sheet 300, the UDD module 118 may identify all plan sheets for the storm water system that include the inlet. Specifically, and in an embodiment, the UDD module 118 may identify all other plan sheets that include the unique identifier assigned to the inlet in the plan set. Based on the identification, the UDD module 118 may filter and only display those plan sheets, in a hierarchical order, that include a representation of the inlet 310.

In an embodiment, the UDD module 118 may filter the plurality of plan sheets that make up a plan set for the infrastructure based on a selection of a spatial boundary of the plan sheet. As explained herein, a spatial boundary of a plan sheet corresponds to a location, e.g., region, in the model, e.g., 3D model. Therefore, and based on a selection of a spatial boundary of a plan sheet, the UDD module 118 may identify all plan sheets for the storm water system that include the same spatial boundary that corresponds to the location in the model.

For example and based on the filtering that is performed when the spatial boundary 320 from plan sheet 300 is selected, the UDD module 118 may identify all other plan sheets for the storm water system that include the same spatial boundary. As such, the UDD module 118 may filter and only display those plan sheets that include the spatial boundary. In an embodiment, the plan sheets filtered based on a spatial boundary may be presented/displayed in a hierarchical order.

The procedure continues to step 220 and the UDD module 118 determines if a 3D object exists for the object selected from the plan sheet. In certain instances, a 3D model of an infrastructure may not include a 3D representation of an object that is included in the plan sheet. For example, during the design of an infrastructure, a plan sheet may be created that includes one or more objects that are deemed to be integral to the creation and deployment of the infrastructure in the real-word environment.

However, and for any of a variety of different reasons, the 3D model that is generated may not include a 3D representation of an object that is included in a plan sheet. For example, let it be assumed that a plan sheet for the storm water system includes a valve at a particular location. During the construction of the 3D model of the storm water system, an engineer or designer may believe that the valve is not necessary or may forget to include the valve in the 3D model of the storm water system. Therefore, and in this hypothetical example, a plan sheet for the storm water system would include a representation of the valve, however the one or more schematics, e.g., 3D schematics, of the storm water system would not include a representation, e.g., 3D representation, of the valve.

If the UDD module 118 determines that a 3D object does not exist for the object selected from the plan sheet at step 220, the procedure continues to step 225. At step 225, the UDD module 118 provides a notification indicating that the 3D object does not exist. For example, the UDD module 118 may display a notification on a computer display of client device 110 that the 3D object does not exist. The procedure continues from step 225 to step 230. At step 230, the procedure ends.

If at step 220 the UDD module 118 determines that a 3D object exists for the object selected from the plan sheet, the procedure continues to step 235. At step 235, the UDD module 118 generates an interface node on a user interface based on the selection of the object from the plan sheet. In an embodiment, the interface node may be a selectable, e.g., clickable, radio button, a selectable checkbox, a selectable drop-down menu, or any other type of interface node that may be selectable or may be identified on a user interface. In an embodiment, the interface node may be displayed on the plan sheet or may be displayed adjacent to the plan sheet. For this example, let it be assumed that the interface node is a radio button that is displayed on plan sheet 600.

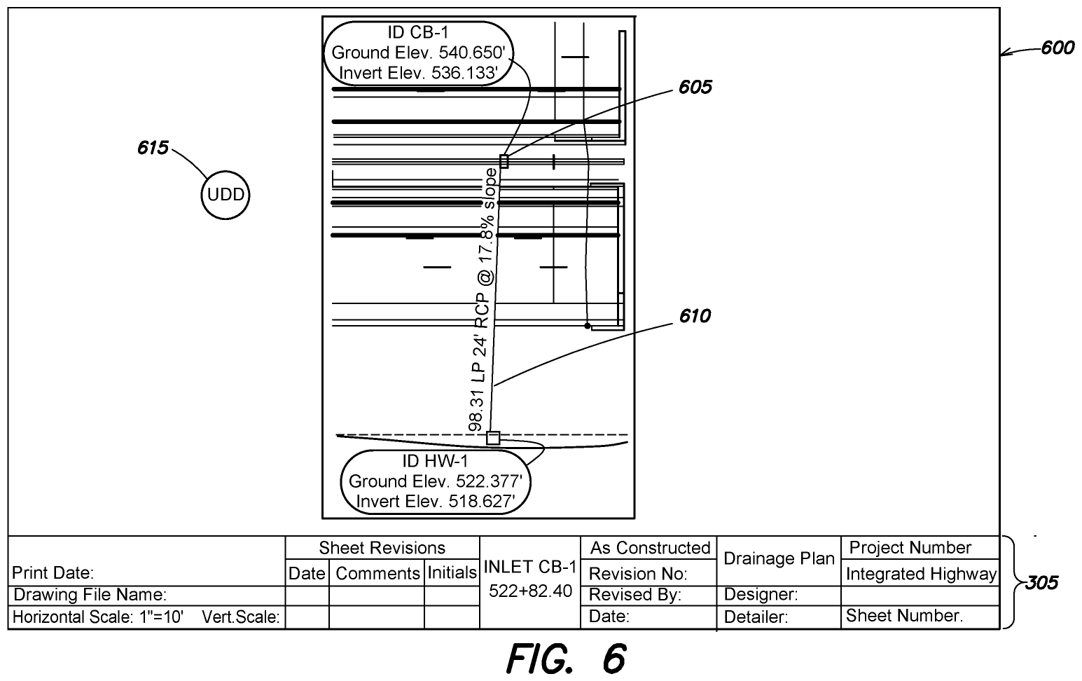

FIG. 6 is a plan sheet corresponding to FIG. 3 that includes an interface node according to the one or more embodiments as described herein. As depicted in FIG. 6, the plan sheet 600 includes inlet 605 and pipe 610 that is connected to inlet 605. Plan sheet 600 further includes interface node 615 that is, in this example, a radio button. In this example, interface node 615 includes text of “UDD”, asking the user if the user wants a UDD of the infrastructure presented. In an embodiment, the interface node 615 is selectable if a user operating client device 110 wants to present a UDD according to the one or more embodiments as described herein and as described in further detail below.

Although FIG. 6 displays interface node 615 on plan sheet 600, it is expressly contemplated that the interface node 615 may be displayed adjacent to the plan sheet 600 on a computer display of client device 110. Alternatively, and according to the one or more embodiments as described herein, the interface node 615 may be displayed individually, e.g., without plan sheet 600, on a computer display of client device 110.

In an embodiment, generating an interface node comprises making each of the objects in the plan sheet 300 clickable or selectable. Stated another way, generating an interface node, according to the one or more embodiments as described herein, may include transforming each object in the plan sheet from being a static object to being a clickable/selectable object. In an embodiment, the UDD module 118 may perform the transformation by modifying the physical representation of an object from static to clickable. As a result, and as will be described in further detail below, clicking a selectable object may cause the UDD module 118 to present a UDD according to the one or more embodiments as described herein.

The procedure continues to step 240 and the UDD module 118 determines that the interface node is selected. In an embodiment, a user may utilize an input device of client device 110 to select the interface node and/or an object that is transformed from being static to being selectable/clickable. For example, an engineer may utilize a mouse of client device 110 to select interface node 615 that is included on plan sheet 600 and/or again selecting inlet 605.

In an embodiment, the filtering of the plan sheets as described in relation to step 215 may be performed in response determining that the interface node is selected. Stated another way, instead of the filtering the plan sheets based on the selection of an object (inlet 310) from a plan sheet, the plan sheets may be filtered by the UDD module 118 in response to selecting interface node 615.

The procedure continues to step 245 and the UDD module 118 presents a UDD for the infrastructure based on the selection of the interface node. In this example, the UDD module 118 presents a UDD of the storm water system based on the selection of interface node 615. In an embodiment, presenting the UDD for an infrastructure includes displaying, on a computer display, at least (1) a plan sheet for an infrastructure and (2) a 3D schematic, e.g., model, of the infrastructure that includes one or more objects included in the displayed plan sheet.

In an embodiment, presenting the UDD for infrastructure includes displaying, on a computer display, at least (1) a plan sheet for an infrastructure, (2) a 3D schematic, e.g., model, of the infrastructure that includes one or more objects included in the displayed plan sheet, and (3) characteristic information corresponding to the one or more objects included in the displayed plan sheet and the 3D schematic.

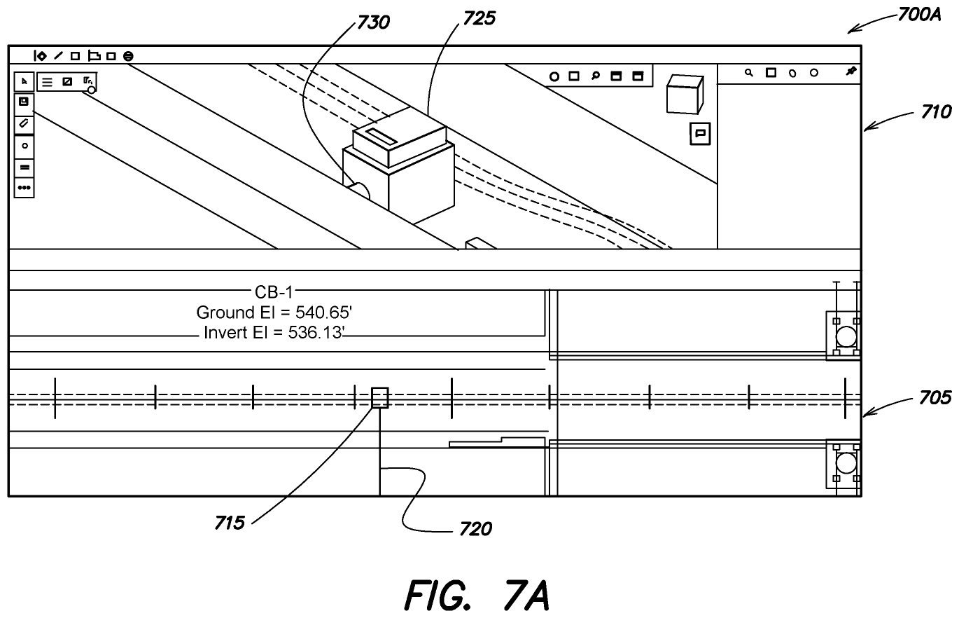

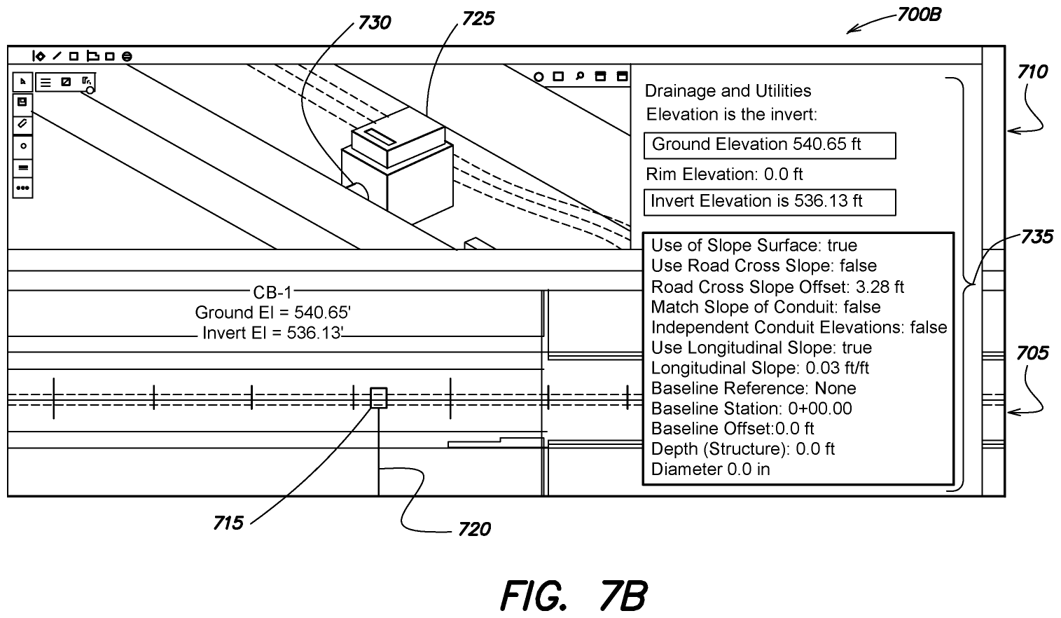

FIG. 7A is an illustration of an example UDD for an infrastructure according to the one or more embodiments as described herein. UDD 700A includes plan sheet 705 for the example storm water system and a portion of a 3D schematic 710 for the storm water system. The plan sheet 705 for the storm water system includes inlet 715 and pipe 720 that is connected to inlet 715. The portion of the 3D schematic 710 of the storm water system includes at least the 3D representation of the inlet 725_{[JL1]} FIG. 7A since the inlet was selected from plan sheet 300, e.g., at step 215. For this example, the portion of the 3D schematic 710 also includes pipe 730 that is connected to inlet 725_{[JL2]} in FIG. 7A, since inlet 715 and pipe 720 are included in plan sheet 705.

In an embodiment, the UDD module 118 may generate and display plan sheet 705 with a 3D model of the entire storm water system in response to the selection of the inlet at step 215. Subsequently, and based on the selection of the interface node 615, the UDD module 118 may “zoom in” or focus the 3D model of the storm water system such that only the portion of the 3D schematic 710_{[JL3]} of the storm water system, that includes inlet 725 and pipe 730 in FIG. 7A, is displayed. As such, the UDD module 118 may present, i.e., display, UDD 700A that includes at least a plan sheet corresponding to the storm water system, i.e., infrastructure, and a portion of a 3D schematic that includes at least one object included in the displayed plan sheet.

In an embodiment, the filtering of the plan sheets as described in relation to step 215 may be performed in response to selecting an object from the presented UDD. Stated another way, instead of filtering the plan sheets based on the selection of an object (inlet 310) from a plan sheet before the UDD is presented, the plan sheets may be filtered by the UDD module 118 in response to selecting an object (e.g., inlet 715 of plant sheet 705 and/or inlet 725_{[JL4]} of 3D schematic 710 of FIG. 7A) of UDD 700A.

FIG. 7B is an illustration of an example different UDD for an infrastructure according to the one or more embodiments as described herein. UDD 700B includes similar elements to UDD 700A of FIG. 7A, however UDD 700B further includes characteristic information 735_{[JL5]} that describes the characteristics/attributes of the inlet that are included in the plan sheet 705 and portion of the 3D schematic 710.

In an embodiment, the UDD module 118 may generate and display the portion of the 3D schematic 710 of the storm water system and the characteristic information 735_{[JL6]} in response to the selection of the interface node 615. Alternatively, the UDD module 118 may generate and display the portion of the 3D schematic of the storm water system in response to the selection of the interface node. The UDD module 118 may then subsequently display the characteristic information 735_{[JL7]} based on receiving an additional input command (e.g., selection of an additional radio button (not shown)), or input of a particular keystroke on a keyboard). As such, the UDD module 118 may present, i.e., display, UDD 700B that includes at least a plan sheet corresponding to the water system, i.e., infrastructure, a portion of a 3D schematic that includes at least one object included in the displayed plan sheet, and characteristic information describing the characteristics/attributes of the objects included in the plan sheet 705 and portion of the 3D schematic 710 of the UDD 700B.

Referring back to procedure 200 of FIG. 2, the procedure continues from step 245 to step 230 where the procedure ends.

The UDD of an infrastructure is “smart” and interactive according to the one or more embodiments as described herein. Additionally, the interactive UDD of the infrastructure is accessible via a plan sheet that is transformed from being static to interactive according to the one or more embodiments as described herein. This contrasts with conventional systems and techniques that commonly provide a static plan sheet as a deliverable.

As previously explained, individuals (e.g., engineers, contractors, surveys, reviewers, inspectors, etc.) who are integral to the planning, design, constructions, and/or operation of the infrastructure may be unfamiliar with utilizing infrastructure modeling software. Because of the lack of familiarity with infrastructure modeling software, these individuals are reluctant to use the infrastructure modeling software and are thus limited to using static plan sheets, which are the common deliverable in the industry, to understand the construction and/or operation of an infrastructure. As a result, with conventional systems and techniques, these individuals are limited to the static information of the plan sheets and do not have access to the more robust data corresponding to the 3D model.

According to the one or more embodiments as described herein, these individuals can now access and utilize the 3D model of the infrastructure and its underlying data via the transformed plan sheet. That is, the individuals do not need to learn or know the different commands, rules, and syntax corresponding to the infrastructure modeling software to access the 3D model and its underlying data. Because these individuals can now access and utilize the 3D model and its underlying data via the transformed plan sheet according to the one or more embodiments as described herein, the individuals more easily and efficiently understand the planning, design, construction, and/or operation of the infrastructure when compared to conventional systems and techniques. Accordingly, the one or more embodiments as described herein provide an improvement in the existing technological field of infrastructure modeling software and digital deliverables for electronic infrastructure planning, design, construction, and/or operation.

It should be understood that a wide variety of adaptations and modifications may be made to the techniques. For example, the steps of the flow diagrams as described herein may be performed sequentially, in parallel, or in one or more varied orders. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

What is claimed is:

1. A method for presenting a unified digital deliverable (UDD) of an infrastructure, the method comprising:
obtaining an assemblage of the infrastructure, the assemblage including at least one or more plan sheets of the infrastructure,
receiving a selection of a plan sheet representation, from a selected plan sheet, of an object of the infrastructure;
in response to receiving the selection, determining if a three-dimensional (3D) representation of the object exists in a 3D representation of the infrastructure;
in response to determining that the 3D representation of the object does not exist, providing an indication that the 3D representation does not exist;
in response to determining that the 3D representation of the object exists in the 3D representation of the infrastructure, presenting a unified digital deliverable (UDD) of the infrastructure,
wherein the UDD comprises at least (1) the one or more plan sheets of the infrastructure and (2) the 3D representation of the infrastructure that includes the 3D representation of the object, wherein the 3D representation of the object is selectable to present characteristic information describing the object of the infrastructure.

2. The method of claim 1, wherein the UDD further comprises a two-dimensional (2D) representation of the infrastructure that is interactive.

3. The method of claim 1, when receiving the selection of the plan sheet representation, the method further comprising:
filtering a plan set, that includes a plurality of plan sheets, by displaying only selected plan sheets that include the object of the infrastructure.

4. The method of claim 1, further comprising:
receiving a selection of 3D representation of the object from the UDD; and
in response to receiving the selection, filtering a plan set, that includes a plurality of plan sheets, by displaying only selected plan sheets that include the object of the infrastructure.

5. The method of claim 1, wherein the assemblage further includes a two-dimensional (2D) model of the infrastructure and the 3D representation of the infrastructure is a 3D model of the infrastructure.

6. The method of claim 5, wherein the 2D model, the 3D model, and the one or more plan sheets are linked.

7. The method of claim 6, further comprising:
identifying a first object of the infrastructure in a selected plan sheet;
identifying the first object of the infrastructure in the 3D model and the 2D model based on the linkage.

8. A system for presenting a unified digital deliverable (UDD) of an infrastructure, the system comprising:
a memory; and
a processor coupled to the memory, the processor configured to:
obtain an assemblage of the infrastructure, the assemblage including at least one or more plan sheets of the infrastructure, receive a selection of a plan sheet representation, from a selected plan sheet, of an object of the infrastructure;
in response to receiving the selection, determine if a three-dimensional (3D) representation of the object exists in a 3D representation of the infrastructure;
in response to determining that the 3D representation of the object does not exist, provide an indication that the 3D representation does not exist;
in response to determining that the 3D representation of the object exists in the 3D representation of the infrastructure, presenting a unified digital deliverable (UDD) of the infrastructure,
wherein the UDD comprises at least (1) the one or more plan sheets of the infrastructure and (2) the 3D representation of the infrastructure that includes the 3D representation of the object, wherein the 3D representation of the object is selectable to present characteristic information describing the object of the infrastructure.

9. The system of claim 8, wherein the UDD further comprises a two-dimensional (2D) representation of the infrastructure that is interactive.

10. The system of claim 8, when receiving the selection of the plan sheet representation, the processor further configured to:
filter a plan set, that includes a plurality of plan sheets, by displaying only selected plan sheets that include the object of the infrastructure.

11. The system of claim 8, wherein the processor further configured to:
receive a selection of 3D representation of the object from the UDD; and
in response to receiving the selection, filter a plan set, that includes a plurality of plan sheets, by displaying only selected plan sheets that include the object of the infrastructure.

12. The system of claim 8, wherein the assemblage further includes a two-dimensional (2D) model of the infrastructure and the 3D representation of the infrastructure is a 3D model of the infrastructure.

13. The system of claim 12, wherein the 2D model, the 3D model, and the one or more plan sheets are linked.

14. The system of claim 13, wherein the processor is further configured to:
identify a first object of the infrastructure in a selected plan sheet;
identify the first object of the infrastructure in the 3D model and the 2D model based on the linkage.

15. A non-transitory computer readable medium having software encoded thereon, the software when executed by one or more computing devices operable to:
obtain an assemblage of the infrastructure, the assemblage including at least one or more plan sheets of the infrastructure,
receive a selection of a plan sheet representation, from a selected plan sheet, of an object of the infrastructure;
in response to receiving the selection, determine if a three-dimensional (3D) representation of the object exists in a 3D representation of the infrastructure;
in response to determining that the 3D representation of the object does not exist, provide an indication that the 3D representation does not exist;
in response to determining that the 3D representation of the object exists in the 3D representation of the infrastructure, presenting a unified digital deliverable (UDD) of the infrastructure,
wherein the UDD comprises at least (1) the one or more plan sheets of the infrastructure and (2) the 3D representation of the infrastructure that includes the 3D representation of the object, wherein the 3D representation of the object is selectable to present characteristic information describing the object of the infrastructure.

16. The non-transitory computer readable medium of claim 15, wherein the UDD further comprises a two-dimensional (2D) representation of the infrastructure that is interactive.

17. The non-transitory computer readable medium of claim 15, when receiving the selection of the plan sheet representation, the software when executed by the one or more computing devices further operable to:
filter a plan set, that includes a plurality of plan sheets, by displaying only selected plan sheets that include the object of the infrastructure.

18. The non-transitory computer readable medium of claim 15, the software when executed by the one or more computing devices further operable to:
receive a selection of 3D representation of the object from the UDD; and
in response to receiving the selection, filter a plan set, that includes a plurality of plan sheets, by displaying only selected plan sheets that include the object of the infrastructure.

19. The non-transitory computer readable medium of claim 15, wherein the assemblage further includes a two-dimensional (2D) model of the infrastructure and the 3D representation of the infrastructure is a 3D model of the infrastructure.

20. The non-transitory computer readable medium of claim 19, wherein the 2D model, the 3D model, and the one or more plan sheets are linked.
